(19) United States
(12) Patent Application Publication
(10) Pub. No.: US 2015/0019281 A1
(43) Pub. Date: Jan. 15, 2015

(54) Product transition for chain of stores with sales velocity based replenishment cutoff

(71) Applicant: Mohit Juneja, Fremont, CA (US)

(72) Inventor: Mohit Juneja, Fremont, CA (US)

(21) Appl. No.: 13/844,974

(22) Filed: Jul. 9, 2013

(51) Int. Cl. G06Q 10/06; G06Q 10/08

(52) U.S. Cl. CPC G06Q 10/06315; G06Q 10/087
USPC 705/7.25

(57) ABSTRACT

This invention relates to the introduction of new products into a chain of stores in a manner that minimizes out of stock at store as well as cannibalization of sales by a previous product that the new product replaces. The new product could be a new model in the case of consumer electronics products like TVs, cameras and phones or a new packaging in the case of consumer packaged goods like food and beverage products. Typical store chains initiate or stop product purchases across the chain of stores when replacing an older product with a new product. Utilizing an approach of grouping stores by sales velocity and utilizing different cutoff dates for replenishing old products ahead of new product launch across the chain of stores, a retail chain can minimize lost sales at faster turning stores and minimize cannibalization of sales at slower turning stores.

### TECHNICAL FIELD AND INDUSTRIAL APPLICABILITY OF INVENTION

This invention relates to the introduction of new products into a chain of stores in a manner that minimizes out of stock at store as well as cannibalization of sales by a previous product that the new product replaces.

### BACKGROUND OF THE INVENTION

A chain of stores launches new products frequently and usually each category of products that the stores carry has a predefined assortment which changes over time. When a new product is launched (example: model A1), it requires a decision to stop purchasing the old product (example: model A) that it replaces, the date the new product is launched in the stores and the subset of stores that would carry this product. Traditionally this decision has always been carried out at the national or chain-wide level without considering how the original product sold at individual stores.

Usually, the original product could be selling at fast turning stores much faster than slow turning stores. A typical new product introduction would require cutting off replenishment for all stores that carry the product a certain number of weeks prior to new model introduction. Due to the replenishment cutoff, the fast turning stores selling the old product sell out first leading to lost sales at these stores. The slowest turning stores don't sell out of the old product by the introduction date of the new product leading to cannibalization of sales of the new product.

The invention is a method of introducing new products where the replenishment cutoff does not happen for all stores at the same time. If the replenishment cutoff is timed based on the rate of sale and inventory at store, it is possible to avoid lost sales at fast turning stores and cannibalization of sales at slow turning stores. By timing the replenishment cutoff based on current inventory and rate of sale, both the stock out and cannibalization of sales can be avoided. It requires the replenishment cutoff decision to be taken by individual store or group of stores based on sales velocity.

The Figures in the attached drawings show an example of how this method of introducing products would work.

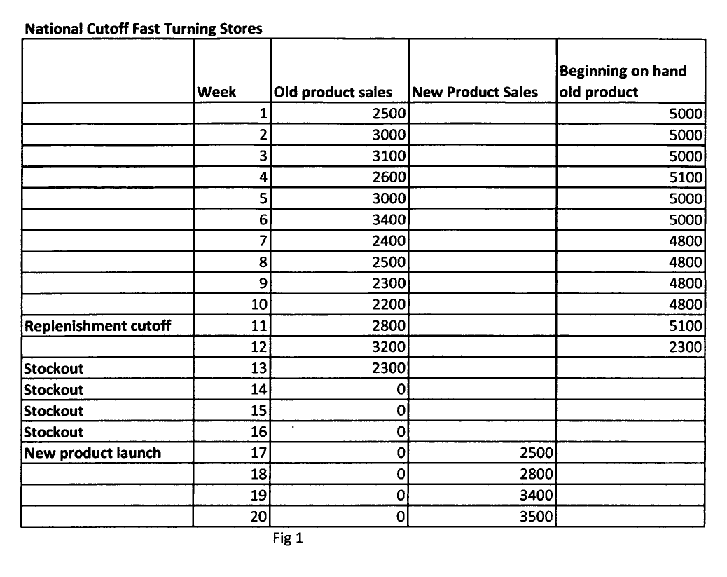

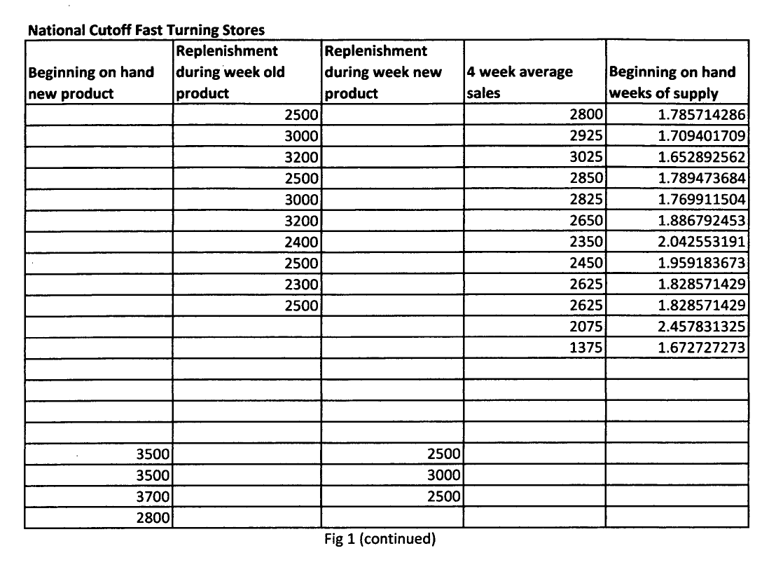

The columns in the FIG. 1 through FIG. 6 represent the following:

| | |
|---|---|
| Week: | Week number in a calendar year. |
| Old product sales: | Unit sales of the old product. |
| New product sales: | Unit sales of the new product replacing the |
| | old product. |
| Beginning on hand | Inventory at the beginning of a week for old |
| old product: | product. |
| Beginning on hand | Inventory at the beginning of a week for new |
| new product: | product. |
| Replenishment | Deliveries of old product units during the week |
| during the week | into store group. |
| old product: | |
| Replenishment | Deliveries of new product units during the week |
| during the week | into store group. |
| new product: | |
| 4 week moving | Moving average of sales. |
| average of sales: | |
| Beginning on hand | Beginning on hand of old product/4 week |
| weeks of supply: | moving average of sales. |

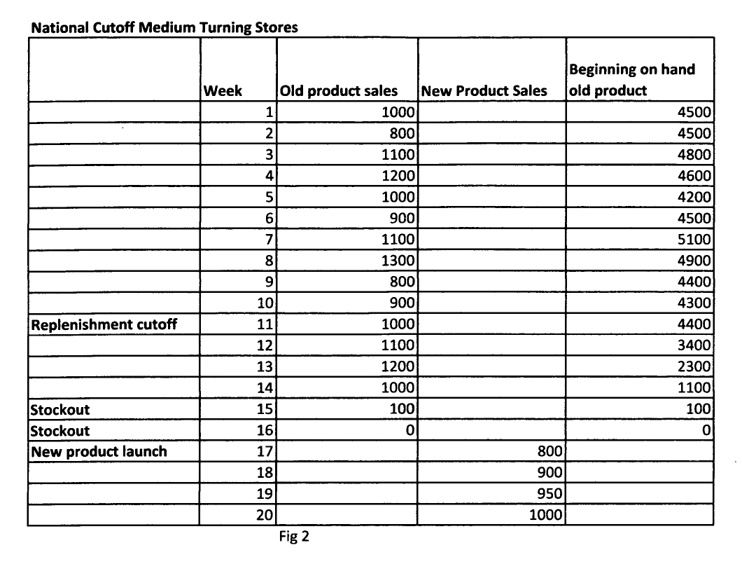

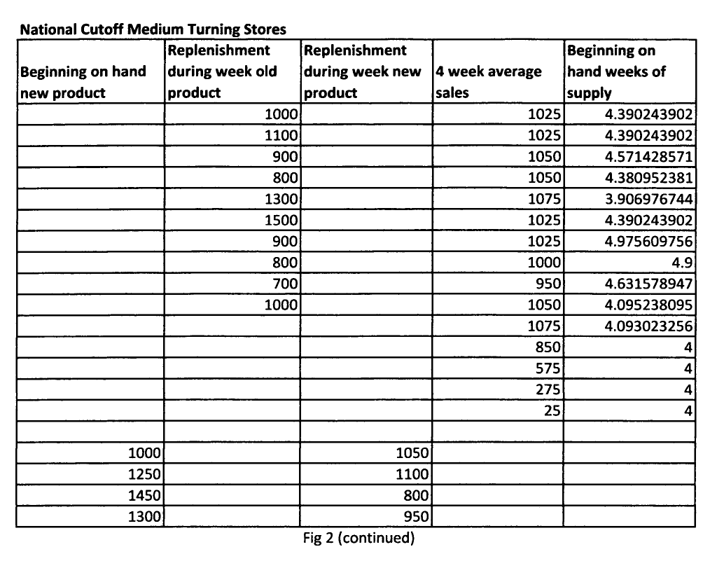

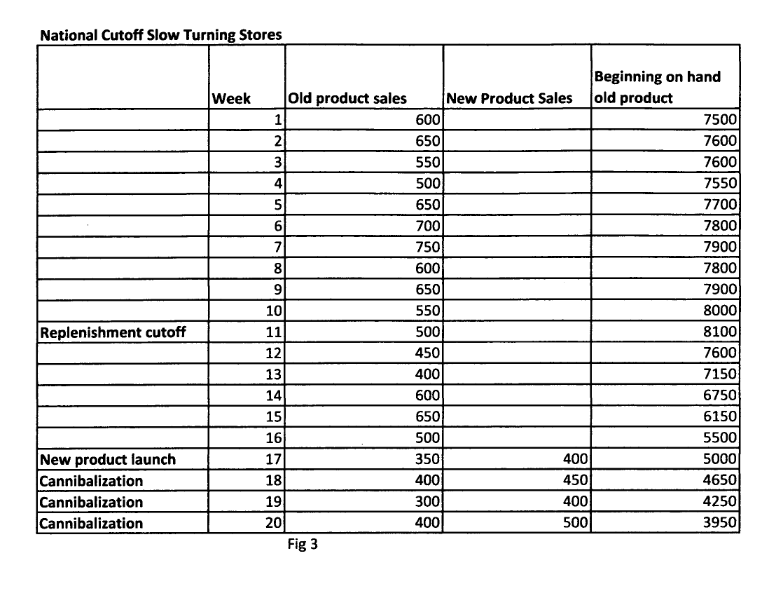

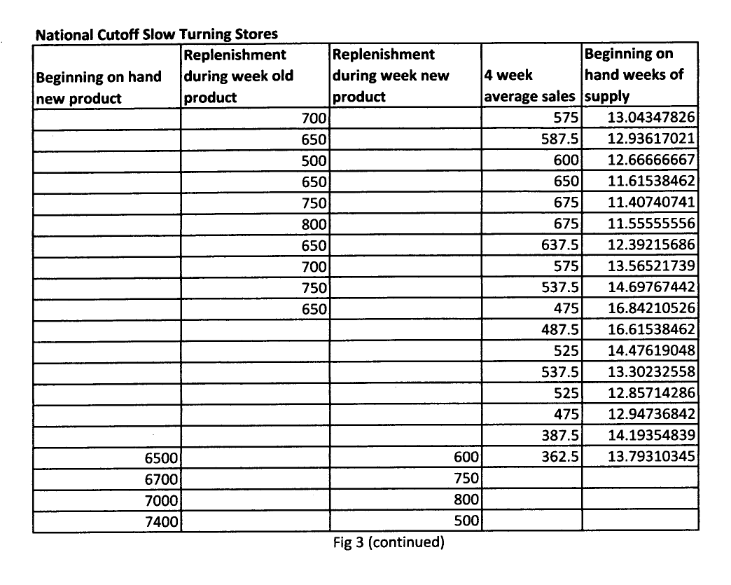

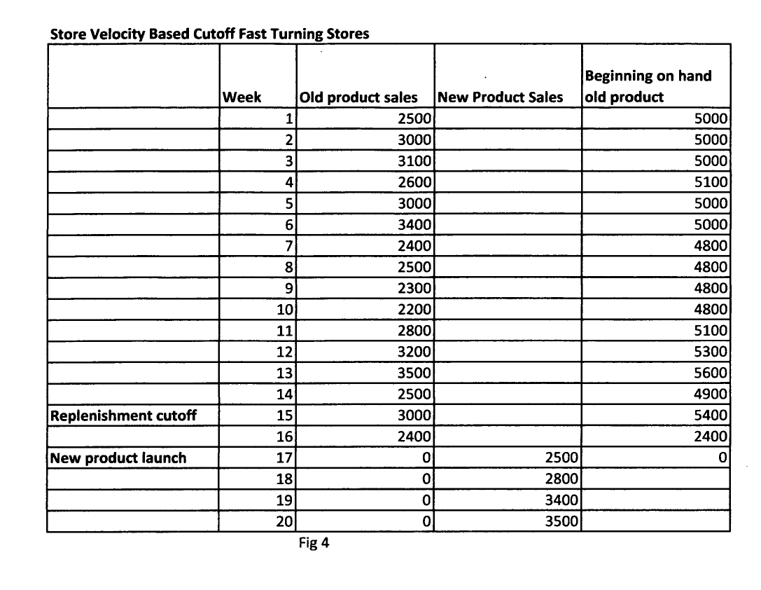

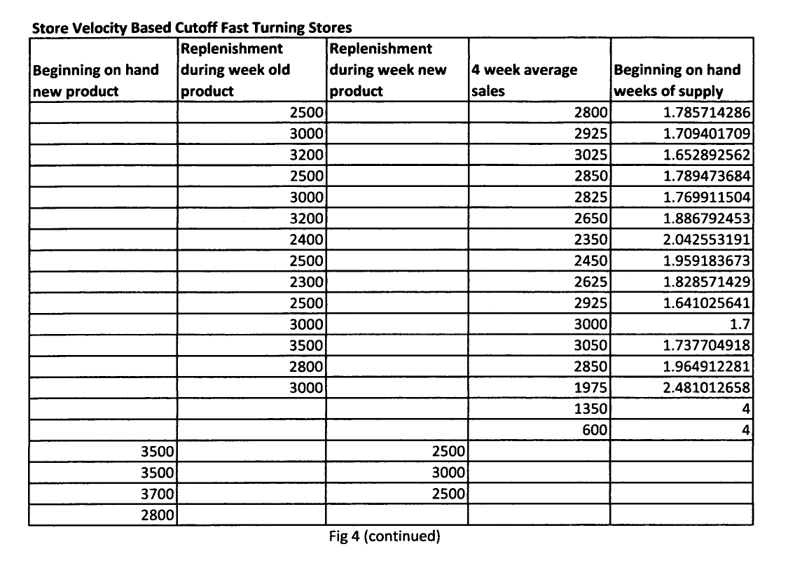

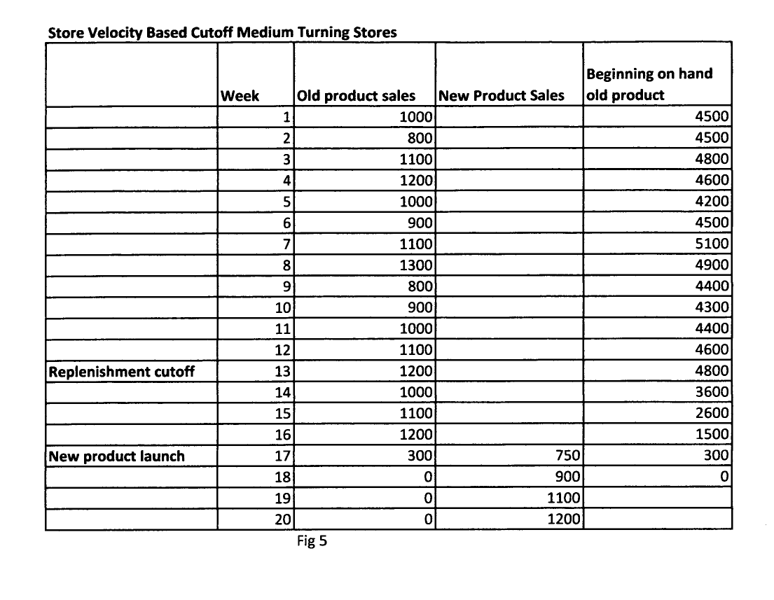

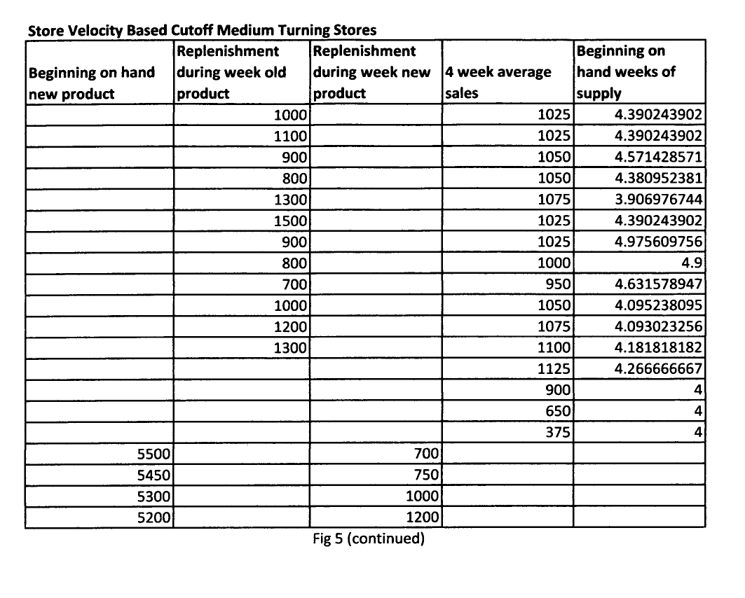

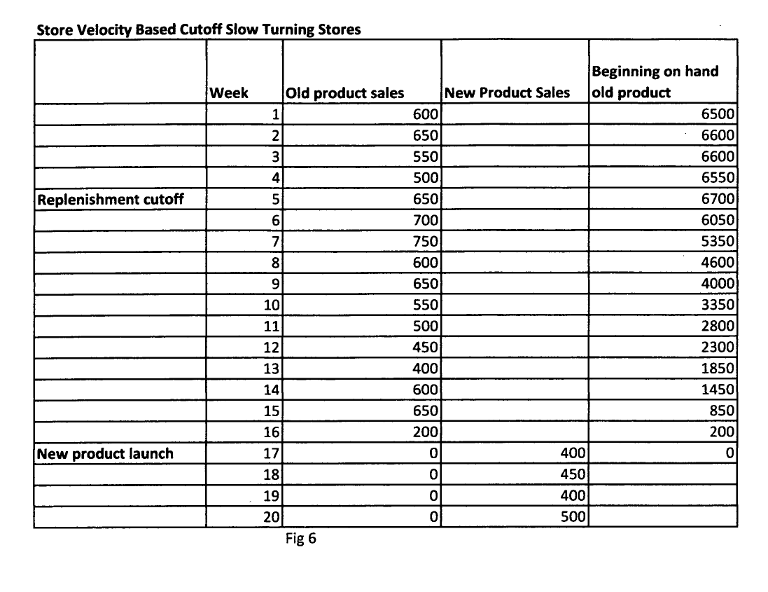

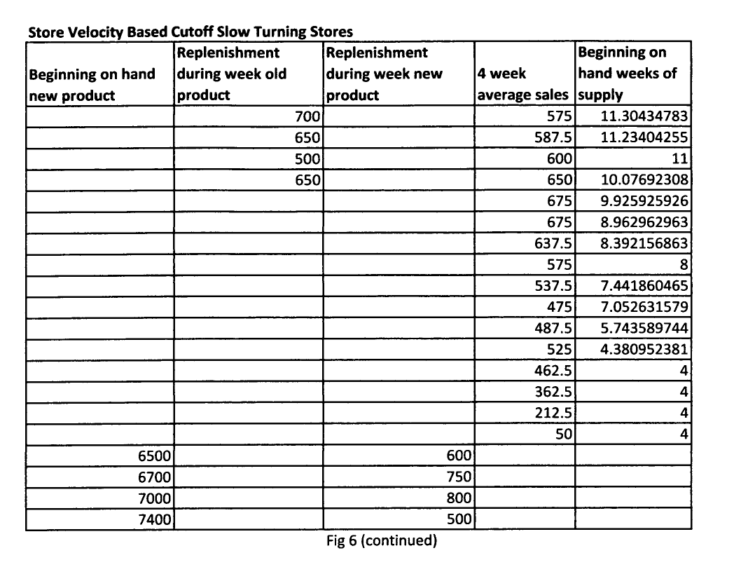

FIG. 1, FIG. 2 and FIG. 3 demonstrate the traditional national cutoff of old product replenishment prior to the launch of the new product while FIG. 4, FIG. 5 and FIG. 6 demonstrates the sales velocity based replenishment cutoff.

FIG. 1 shows that when a chain of stores uses a national or chain wide cutoff of replenishment of an old product, the fastest turning stores stock out due to no sellable inventory remaining before the new product is launched. Weeks 13 to 16 demonstrate this stock-out with the consequent loss in sales before the new product is launched.

FIG. 2 shows that when a chain of stores uses a national or chain wide cutoff of replenishment of an old product, the medium turning stores stock out due to no sellable inventory remaining before the new product is launched. Weeks 15 and 16 demonstrate this stock-out with consequent loss in sales before new product is launched.

FIG. 3 shows that when a chain of stores uses a national or chain wide cutoff of replenishment of an old product, the slowest turning stores experience cannibalization due to excess inventory of old product before the new product is launched. Weeks 17 to 20 demonstrate the cannibalization of sales of new product with sales of the old product inventory still available at these stores.

FIG. 4 shows that when a chain of stores uses sales velocity based replenishment cut-off of an old product, the fastest turning stores don't stock out or experience cannibalization when the new product is launched. Compared to FIG. 1, the sales velocity based replenishment cutoff is done based on beginning on hand weeks of supply in week 14 of 2.48 weeks. No replenishment in subsequent weeks results in no stock-out of old product sales in week 15 or week 16 and no cannibalization of sales when the new product is launched in week 17.

FIG. 5 shows that when a chain of stores uses sales velocity based replenishment cut-off of an old product, the medium turning stores don't stock out or experience cannibalization when the new product is launched. Compared to FIG. 2, the sales velocity based replenishment cutoff is done based on a beginning on hand weeks of supply in week 12 of 4.18. No replenishment in subsequent weeks results in no stock-out of old product sales in week 13, week 14, week 15 or week 16 and no cannibalization of sales when the new product is launched in week 17.

FIG. 6 shows that when a chain of stores uses sales velocity based replenishment cut-off of an old product, the slow turning stores don't stock out or experience cannibalization when the new product is launched. Compared to FIG. 3, the sales velocity based replenishment cutoff is done based on a beginning on hand weeks of supply in week 4 of 10.07. No replenishment in subsequent weeks results in no stock-out of old product sales in week 5,week 6, week 7, week 8, week 9, week 10, week 11, week 12, week 13, week 14, week 15 or week 16 and no cannibalization of sales when the new product is launched in week 17.

What is claimed is:

1. A method to introduce a new product at a store or group of stores based on sales velocity and current inventory, eliminates both stockouts and cannibalization of sales, as opposed to using a traditional method of cutting off replenishment of old product ahead of new product introduction chain-wide or nationally for all stores carrying the products.
